(19) United States
(12) Patent Application Publication
(10) Pub. No.: US 2007/0083712 A1
(43) Pub. Date: Apr. 12, 2007

(54) Method, apparatus, and computer program product for implementing polymorphic reconfiguration of a cache size

(75) Inventors: Jeffrey Powers Bradford, Rochester, MN (US); Todd Alan Christensen, Rochester, MN (US); Richard James Eickemeyer, Rochester, MN (US); Timothy Hume Heil, Rochester, MN (US); Harold F. Kossman, Rochester, MN (US); Timothy John Mullins, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: International Business Machines Corporation, Armonk, NY (US)

(21) Appl. No.: 11/246,819

(22) Filed: Oct. 7, 2005

(51) Int. Cl. G06F 12/00

(52) U.S. Cl. 711/118

(57) ABSTRACT

A method, apparatus and computer program product are provided for implementing polymorphic reconfiguration of a cache size. A cache includes a plurality of physical sub-banks. A first cache configuration is provided. Then checking is provided to identify improved performance with another cache configuration. The cache size is reconfigured to provide improved performance based upon the current workload.

### FIELD OF THE INVENTION

The present invention relates generally to the data processing field, and more particularly, relates to a method, apparatus and computer program product for implementing polymorphic reconfiguration of a cache size.

### DESCRIPTION OF THE RELATED ART

Computers have become increasingly faster and one of the ways in which to increase the speed of computers is to increase the clock speed of the processors. Computer system performance is limited by processor stalls when the processor must wait for data from memory to continue processing. In order to reduce data access time, special purpose high-speed memory spaces of static random access memory (RAM) called a cache are used to temporarily store data which are currently in use. For example, the cached data can include a copy of instructions and/or data obtained from main storage for quick access by a processor.

A processor cache typically is positioned near or integral with the processor. Data stored in the cache advantageously may be accessed by the processor in only one processor cycle retrieving the data necessary to continue processing; rather than having to stall and wait for the retrieval of data from a secondary memory, such as a higher level cache memory or main memory.

Since cache size directly impacts cache latency, processor designs must decide between a smaller cache with shorter latency, or a bigger cache with a longer latency.

Various computer applications require varying amounts of cache to run well. Since many processors are designed to run well over a wide range of applications, caches are often sized for larger applications.

Since larger caches result in longer access times, applications that can perform well in a smaller cache needlessly suffer from the longer access times imposed by the demands of other workloads.

### SUMMARY OF THE INVENTION

Principal aspects of the present invention are to provide a method, apparatus and computer program product for implementing polymorphic reconfiguration of a cache size. Other important aspects of the present invention are to provide such method, apparatus and computer program product for implementing polymorphic reconfiguration of a cache size substantially without negative effect and that overcome many of the disadvantages of prior art arrangements.

In brief, a method, apparatus and computer program product are provided for implementing polymorphic reconfiguration of a cache size. A cache includes a plurality of physical sub-banks. A first cache configuration is provided. Checking is provided to identify improved performance with another cache configuration. The cache size is reconfigured to provide improved performance based upon the current workload.

In accordance with features of the invention, in a small cache size configuration, a physical sub-bank of the cache closest to user logic is used. A wire delay for both sending a request to cache and for retrieving data from the cache is minimized when the closest physical sub-bank of the cache is used for the small cache size configuration.

In accordance with features of the invention, each physical sub-bank of the cache not being used in a small cache size configuration is powered down. Alternatively, one or more physical sub-banks of the cache not being used in a small cache size configuration can be used to store other information.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for implementing polymorphic reconfiguration of cache size in accordance with the preferred embodiment;

FIG. 2 is a diagram illustrating exemplary sub-bank arrangement of a cache of the computer system of FIG. 1 in accordance with the preferred embodiment;

FIGS. 3A and 3B are diagrams respectively illustrating exemplary timing for a full size configuration of the cache and a quarter size configuration of the cache in accordance with the preferred embodiment;

FIG. 4 is a flow diagram illustrating exemplary morphing algorithm steps for implementing polymorphic reconfiguration of cache size in accordance with the preferred embodiment; and

FIG. 5 is a block diagram illustrating a computer program product in accordance with the preferred embodiment.

### DETAILED DESCRIPTION OF THE PREFERRED EMBODIMENTS

In accordance with features of the preferred embodiment, the method for reconfiguring the cache size is adapted to match the needs of the workload. The cache is configured into a small/fast mode of operation for workloads that can fit in a small cache. For workloads that require the entire cache, the entire cache is used. The method for implementing polymorphic reconfiguration of cache size is performed using a cache physical sub-banking commonly used in cache arrays. The decision to switch cache size configurations can be made by software, and/or by adaptive hardware learning.

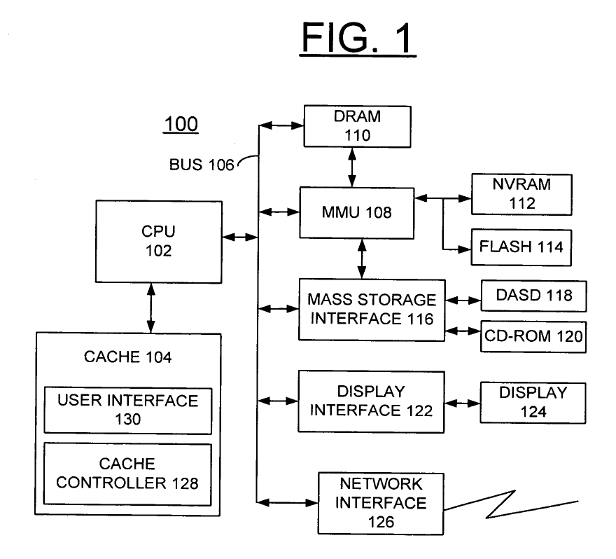

Having reference now to the drawings, in FIG. 1, there is shown a computer system generally designated by the reference character 100 for implementing polymorphic reconfiguration of cache size in accordance with the preferred embodiment. As shown in FIG. 1, computer system 100 includes a central processor unit (CPU) 102 coupled to a static random access memory or cache 104. CPU 102 is coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106. Computer system 100 includes a cache controller 128 arranged together with cache 104 for implementing the polymorphic cache size reconfiguration method and apparatus in accordance with the preferred embodiment. Computer system 100 includes a user interface 130 arranged together with the cache controller 128 for implementing user selected reconfiguration control inputs.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors, each used with at least one associated cache.

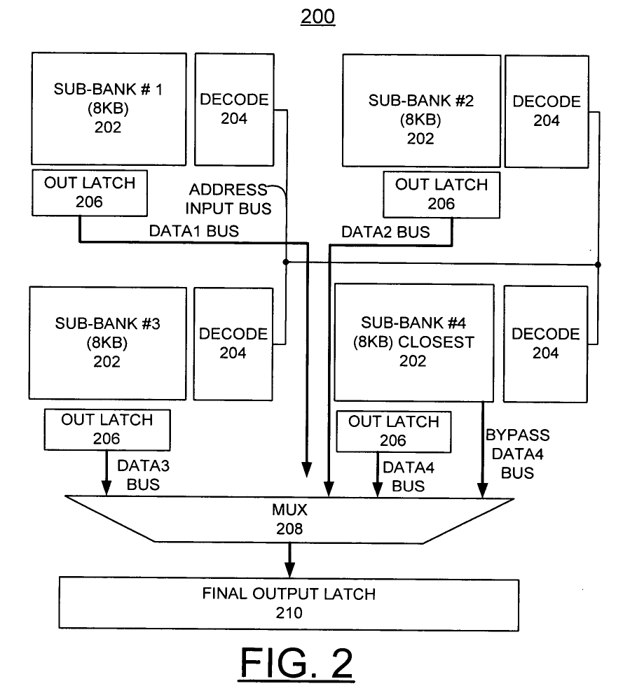

Referring to FIG. 2, there is shown an exemplary sub-bank arrangement generally designated by the reference character 200, for example, provided for the cache 104 of the computer system 100 in accordance with the preferred embodiment. Cache sub-bank arrangement 200 includes a plurality of sub-banks 202 # 1-4. Each of sub-banks 202 includes an associated decode 204 and an associated out latch 206. An address input bus is coupled to each sub-bank decode 204.

A final output latch 210 is coupled via a multiplexer 208 to each out latch 206 associated with the respective sub-banks 202 # 1-4. A respective data #1-4 output bus connects each respective out latch 206 associated with the respective sub-banks 202 # 1-4 to the multiplexer 208. A bypass data #4 output bus directly connects the sub-bank 202 # 4 to the final output latch 210, bypassing the associated out latch 206.

For example as shown in FIG. 2, a 32 KB 4-way L1 cache arrangement 200 is illustrated for cache 104. The cache 104 is broken into the four physical sub-banks 202, each 8 KB. This physical sub-banking conventionally can be provided in a cache to improve throughput and access time.

In a large cache size configuration, each of the plurality of sub-banks 202 # 1-4 is used. The large cache size configuration is provided for workloads or larger applications that require the entire cache.

In a small cache size configuration, the physical sub-bank 202 # 4 of the cache is used that is closest to user logic. A wire delay for both sending a request to cache and for retrieving data from the cache is minimized by using the closest physical sub-bank 202 # 4 for the small cache size configuration. The small cache size configuration is provided to improve system performance for other workloads or applications where the entire cache is not needed.

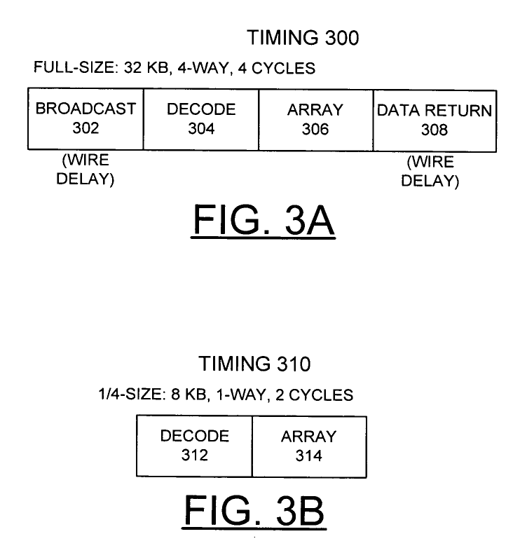

FIG. 3A illustrates exemplary timing generally designated by the reference character 300 for a full size configuration of the cache 200 including the four physical sub-banks 202, #1-4. A first broadcast cycle 302 includes addressing decodes 204 via the address input bus. A second decode cycle 304 includes address decoding by the decodes 204. A third array cycle 306 includes accessing the data sub-banks 202, #1-4. A fourth data return cycle 308 includes returning output data from the sub-banks 202, #1-4 via multiplexer 208, which selects the desired output data and applies the data to the output latch 210 The resulting logical array has a four cycle access time as shown in FIG. 3A. Much of the access time is spent in wire delay particularly in the first broadcast cycle 302 and the data return cycle 308, sending the request to the physically farthest array, and retrieving the data from the same array.

FIG. 3B illustrates exemplary timing for a quarter size configuration of the cache 104 in accordance with the preferred embodiment. For the closest sub-bank 202, #4, the actual wire delay is much less in both directions. In a fast/small configuration, the cache 104 is reduced to only this fast near-by sub-bank202, #4, thereby eliminating most of the wire delay. A staging latch can be bypassed in each direction, saving two cycles in this illustrated example. As fabrication dimensions shrink, it is well known that wire delay becomes increasingly important and implementing polymorphic reconfiguration of cache size in accordance with the preferred embodiment also becomes increasingly important. The benefits of saving two cycles in this illustrated example of FIG. 3B can be, for example 1-5% savings per cycle or 2-10% total, for applicable workloads depending on the CPU design.

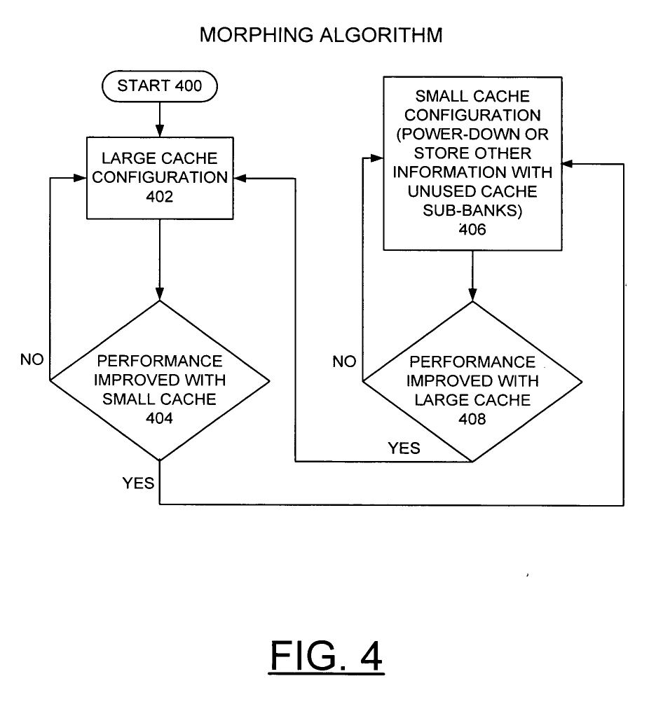

Referring to FIG. 4, there are shown exemplary morphing algorithm steps for implementing polymorphic reconfiguration of cache size in accordance with the preferred embodiment starting at a block 400. As shown, a first cache configuration provided is a large cache configuration as indicated in a block 402. Checking current workload to identify improved performance with another cache configuration or a small cache size configuration is performed as indicated in a decision block 404. A user selected configuration can be provided, for example via a user selected mode bit applied to the cache controller 128.

If the small cache size configuration would not provide improved performance, then the large cache configuration is maintained at block 402. If small cache size configuration would provide improved performance, then the cache is reconfigured as indicated in a block 406. With the small cache configuration, such as using only sub-bank 202, # 4, the other sub-banks 202, # 1-3 optionally are powered down or used to store other information as indicated at block 406.

Checking current workload to identify improved performance with another cache configuration or the large cache size configuration is performed as indicated in a decision block 408. If the large cache size configuration would not provide improved performance, then the small cache configuration is maintained at block 406. If the large cache size configuration would provide improved performance, then the cache is reconfigured to the large cache configuration at block 402.

Cache controller 128 is arranged for implementing method polymorphic reconfiguration of cache size in accordance with the preferred embodiment, such as shown in FIG. 4. Cache controller 128 includes software, and/or adaptive hardware learning to make the decision to switch configurations, for example, as shown at decision blocks 404, 408. It should be understood that various learning algorithms can be used to identify improved performance for implementing polymorphic reconfiguration of cache size in accordance with the preferred embodiment.

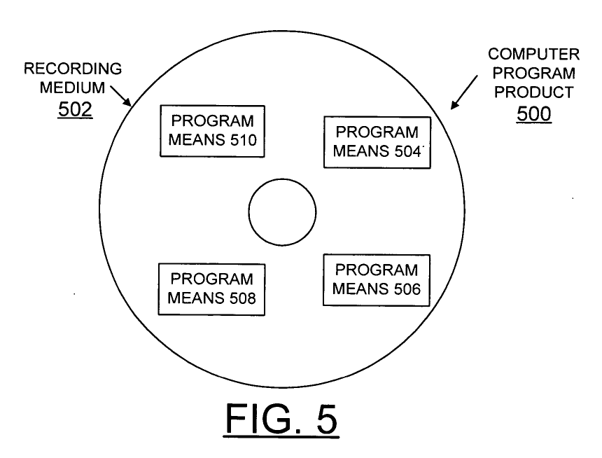

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, a transmission type media such as a digital or analog communications link, or a similar computer program product. Recording medium 502 stores program means 504, 506, 508, 510 on the medium 502 for carrying out the methods for implementing polymorphic reconfiguration of cache size of the preferred embodiment in the system 100 of FIG. 1.

A sequence of program instructions or a logical assembly of one or more interrelated modules defined by the recorded program means 504, 506, 508, 510, direct the computer system 100 for implementing polymorphic reconfiguration of cache size of the preferred embodiment.

While the present invention has been described with reference to the details of the embodiments of the invention shown in the drawing, these details are not intended to limit the scope of the invention as claimed in the appended claims.

What is claimed is:

1. A method for implementing polymorphic reconfiguration of a cache size comprising the steps of:
providing a cache with a plurality of physical sub-banks;
providing a first cache configuration;
checking current workload to identify improved performance with another cache configuration; and
reconfiguring the cache size to provide improved performance responsive to the current workload.

2. A method for implementing polymorphic reconfiguration of a cache size as recited in claim 1 wherein providing said first cache configuration includes providing a large cache size configuration.

3. A method for implementing polymorphic reconfiguration of a cache size as recited in claim 2 wherein providing said large cache size configuration includes configuring said cache to include each of said plurality of said physical sub-banks.

4. A method for implementing polymorphic reconfiguration of a cache size as recited in claim 2 wherein reconfiguring the cache size includes providing a small size cache configuration.

5. A method for implementing polymorphic reconfiguration of a cache size as recited in claim 4 wherein providing said small size cache configuration includes using a physical sub-bank of the cache having minimum wire delay.

6. A method for implementing polymorphic reconfiguration of a cache size as recited in claim 4 wherein providing said small size cache configuration includes using a physical sub-bank of the cache closest to user logic.

7. A method for implementing polymorphic reconfiguration of a cache size as recited in claim 6 further includes powering down at least one physical sub-bank of the cache not being used in said small cache size configuration.

8. A method for implementing polymorphic reconfiguration of a cache size as recited in claim 6 further includes storing other information using at least one physical sub-bank of the cache not being used in said small cache size configuration.

9. A method for implementing polymorphic reconfiguration of a cache size as recited in claim 1 wherein providing said first cache configuration includes providing a small cache size configuration.

10. A method for implementing polymorphic reconfiguration of a cache size as recited in claim 9 wherein providing said small size cache configuration includes using a predefined physical sub-bank of the cache for minimizing wire delay.

11. A method for implementing polymorphic reconfiguration of a cache size as recited in claim 10 further includes powering down at least one physical sub-bank of the cache not being used in said small cache size configuration.

12. A method for implementing polymorphic reconfiguration of a cache size as recited in claim 10 further includes storing other information using at least one physical sub-bank of the cache not being used in said small cache size configuration.

13. A method for implementing polymorphic reconfiguration of a cache size as recited in claim 1 further includes periodically checking current workload to identify improved performance with another cache configuration, and reconfiguring the cache size to provide improved performance responsive to the current workload.

14. A method for implementing polymorphic reconfiguration of a cache size as recited in claim 1 wherein checking current workload to identify improved performance with another cache configuration includes identifying a user selected cache configuration.

15. A computer program product for implementing polymorphic reconfiguration of a cache size in a computer system including a cache with a plurality of physical sub-banks, said computer program product including instructions executed by the computer system to cause the computer system to perform the steps of:
providing a first cache configuration;
checking current workload to identify improved performance with another cache configuration; and
reconfiguring the cache size to provide improved performance responsive to the current workload.

16. A computer program product for implementing polymorphic reconfiguration of a cache size as recited in claim 15 wherein the step of reconfiguring the cache size to provide improved performance responsive to the current workload includes the step of providing a small size cache configuration by using a predefined physical sub-bank of the cache for minimizing wire delay.

17. A computer program product for implementing polymorphic reconfiguration of a cache size as recited in claim 16 further includes powering down at least one physical sub-bank of the cache not being used in said small cache size configuration.

18. A computer program product for implementing polymorphic reconfiguration of a cache size as recited in claim 16 further includes using at least one physical sub-bank of the cache not being.used in said small cache size configuration for storing other information.

19. Apparatus for implementing polymorphic reconfiguration of a cache size comprising:
a cache with a plurality of physical sub-banks;
a cache controller for providing a first cache configuration;
said cache controller for checking current workload to identify improved performance with another cache configuration; and
said cache controller for reconfiguring the cache size to provide improved performance responsive to the current workload.

20. Apparatus for implementing polymorphic reconfiguration of a cache size wherein said cache controller includes adaptive learning hardware.
